(19) United States
(12) Patent Application Publication
(10) Pub. No.: US 2013/0177675 A1
(43) Pub. Date: Jul. 11, 2013

(54) Image bearing novelty cupcake

(71) Applicant: John T. Abbott, Hamilton, NJ (US)

(72) Inventor: John T. Abbott, Hamilton, NJ (US)

(21) Appl. No.: 13/374,705

(22) Filed: Jan. 9, 2012

(51) Int. Cl. A21D 13/08; A23P 1/08; A21D 6/00

(52) U.S. Cl. 426/87; 426/383; 426/132

(57) ABSTRACT

The disclosure involves producing edible cupcakes, each cupcake having an image transfer film positioned on an inside surface of a conventional cupcake baking cup wrapper, the image transfer film having an image of an edible ink thereon, inserting cake batter into the cupcake baking cup wrapper, and baking the batter, for producing a finished cupcake, which melts the edible ink due to the elevated temperatures during baking and causes the image of the edible ink to be transferred upon a wall of the baked cupcake. When people in social groups randomly select the cupcakes, and peel away the cupcake wrappers, the images, which can be printed messages, are suddenly revealed to the surprised person and can be used in connection with entertaining contests or games. The images could also be graphic pictures suggesting seasons of the year or holidays, or messages of welcome.

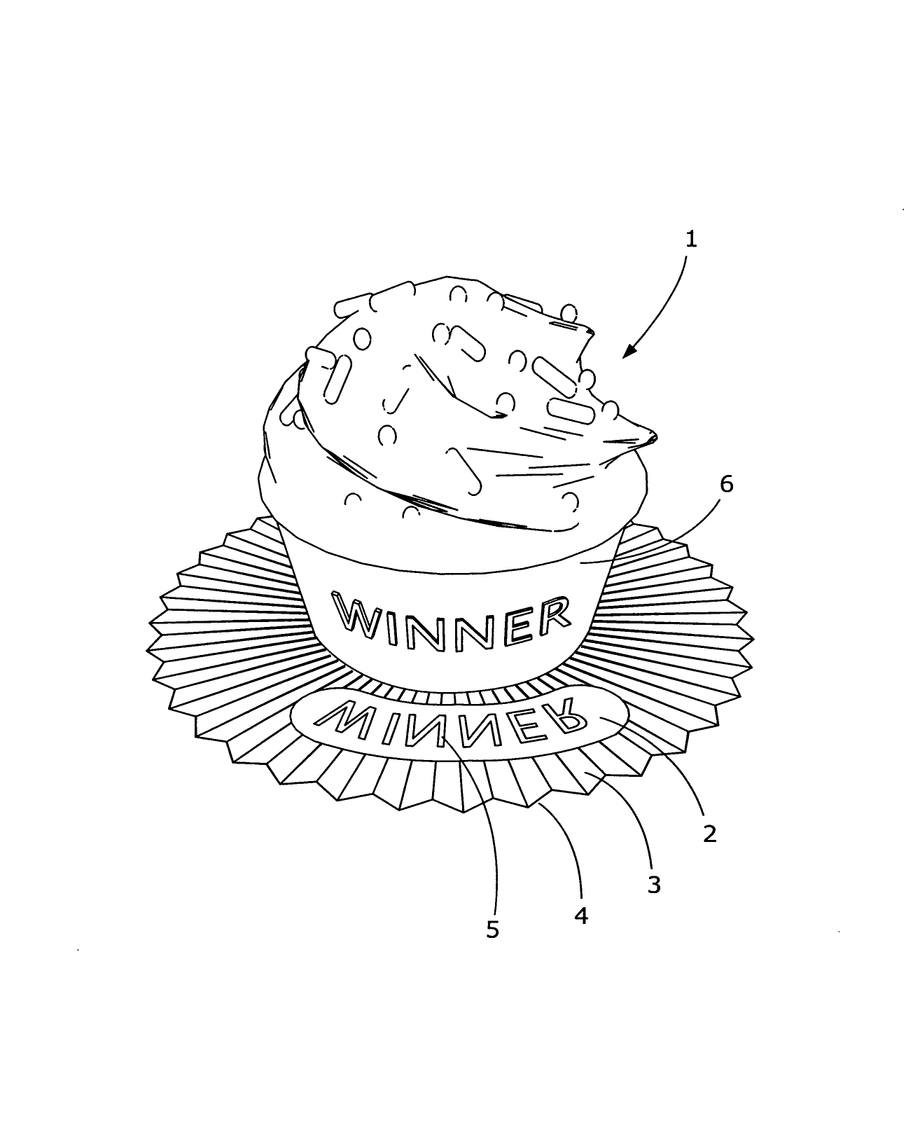

### BACKGROUND OF THE INVENTION

This invention relates to the field of baked goods.

U.S. Pat. No. 4,285,978 to Quinlivan discloses a method for decorating baked goods by transferring a preprinted design from a transfer material to an uncooked dough surface.

Candler et al. 2003/0097949 teaches printing upon an edible article with edible ink.

U.S. Pat. No. 3,537,406 issued to Ort is directed to printing a design prior to baking.

### BRIEF SUMMARY OF PREFERRED EMBODIMENTS OF THE INVENTION

The method of the invention involves producing an edible cupcake having an image transfer film positioned on the inside surface of a conventional cupcake baking cup, the image transfer film having an image of an edible ink thereon, inserting cake batter into the cupcake baking cup, and baking the batter for producing a finished cupcake which melts the edible ink and causes the image of the edible ink to be transferred upon an outer wall of the baked cupcake.

At a social event such as a children's party, the cupcake baking cup is removed from the cupcake for surprisingly revealing the image of the edible ink upon the cupcake.

Also, a kit, which can be supplied to a cook, comprising one or more imaging items, each imaging item having an image transfer device positioned upon the inside surface of a cupcake baking cup, each image transfer device having an image of an edible substance thereon which can be transferred, by being heated, to a cupcake batter positioned within the baking cup during baking.

### BRIEF DESCRIPTION OF THE DRAWING

The sole figure discloses a cupcake with a cupcake wrapper peeled away to disclose a printed message to a surprised person.

### DETAILED DESCRIPTION OF PREFERRED EMBODIMENTS OF THE INVENTION.

Referring now to the sole figure, the method of the invention involves producing an edible cupcake 1 having an image transfer film 2 positioned on the inside surface 3 of a conventional cupcake baking cup 4, the image transfer film having an image 5 of an edible ink thereon, inserting cake batter into the cupcake baking cup, and baking the batter, for producing a finished cupcake, which melts the edible ink due to the elevated temperatures during baking and causes the image of the edible ink to be transferred upon an outer wall 6 of the baked cupcake.

The preprinted baking cup wrapper would be filled with cupcake batter and baked in an oven at 350 degrees F. for approximately 25 minutes. At about 24 minutes the edible ink melts which leaves an imprint or image on the side of the formed and firm batter. Printing processors with edible inks are known; see for example U.S. Pat. No. 7,608,141 incorporated by reference herein.

The image 5 is a printed readable message as shown in the sole figure. However, the image may take other forms. For example, graphic images may be produced in accordance with various holidays or seasons such as Christmas trees, Hanukkah menorahs, pumpkins, snowmen, flowers, and flags.

The transferred image could be a printed advertising message such as “The Cakebox Shop.”

At a social event, such as for example, a children's party, the cupcake baking cup is removed by peeling it away from the cupcake for surprisingly revealing the image of the edible ink upon the cupcake which could be a printed readable message such as “Happy Birthday”, or “Glad You Could Come.”

Also, the printed readable message could be associated with a gift giveaway game, whereby one or more cupcakes in a first group of cupcakes could reveal a printed message such as “Winner” and a second group of cupcakes could reveal the message “Sorry” indicative of losers . The child randomly picking the winning cupcake would then receive a prize, adding a fun element to a party.

Also, two randomly selected cupcake groups could bear images or printings indicative of a first team and a second team that compete with one another in a contest or game such as the well known children's game “Pin the Tail on the Donkey.”

While the invention has been described in connection with preferred embodiments, the description is not intended to limit the scope of the invention to the particular forms set forth, but on the contrary, it is intended to cover such alternatives, modifications, and equivalents as may be included within the spirit and scope of the invention as indicated by the language of the appended claims.

I claim:

1. A method of producing an edible baked cupcake comprising:
(a) placing an image of an edible substance on the inside surface of a cupcake baking cup;
(b) inserting cake batter into said cupcake baking cup; and
(c) baking the cake batter for producing a finished novelty cupcake which causes the image of the edible substance to be transferred upon a wall of the baked cupcake.

2. The method of claim 1 including removing the cupcake baking cup from the cupcake for surprisingly revealing the image of the edible substance upon the cupcake.

3. The method of claim 1 wherein the image of the edible substance is a printed readable message.

4. The method of claim 2 wherein the image of the edible substance is a printed readable message.

5. The method of claim 4 wherein a first group of cupcakes made in accordance with claim 1 bears one or more first printings thereon and a second group of cupcakes made in accordance with claim 1 bears second printings thereon that differ from said first printings.

6. The method of claim 5 wherein said first printing or printings bears indicia suggesting a winner or winners and said second printings bear indicia suggesting losers.

7. The method of claim 6 wherein the first printings comprises “Winner” and said second printings comprises “Sorry”.

8. The method of claim 5 wherein said first printings bear indicia suggesting a first team and said second printings bear indicia suggesting a second team that will compete with the first team in a game.

9. A method of producing an edible baked cupcake comprising:
(a) placing an image transfer film on the inside surface of a cupcake baking cup, said image transfer film having an image of an edible ink thereon;
(b) inserting cake batter into said cupcake baking cup; and
(c) baking the batter for producing a finished novelty cupcake which causes the image of the edible ink to be transferred upon a wall of the baked cupcake.

10. The method of claim 9 including removing the cupcake baking cup from the cupcake for surprisingly revealing the image of the edible ink upon the cupcake.

11. The method of claim 9 wherein the image of the edible ink is a printed readable message.

12. The method of claim 10 wherein the image of the edible substance is a printed readable message.

13. The method of claim 12 wherein a first group of cupcakes made in accordance with claim 9 bears one or more first printings thereon and a second group of cupcakes made in accordance with claim 9 bears second printings thereon that differ from said first printings.

14. The method of claim 13 wherein said first printing or printings bears indicia suggesting a winner or winners and said second printings bear indicia suggesting losers.

15. The method of claim 14 wherein the first printings comprises “Winner” and said second printings comprises “Sorry”.

16. The method of claim 13 wherein said first printings bear indicia suggesting a first team and said second printings bear indicia suggesting a second team that will compete with the first team in a game.

17. A cupcake made in accordance with the method of claim 1.

18. A cupcake made in accordance with the method of claim 9.

19. A cupcake made in accordance with the method of claim 1 wherein the image of the edible substance is a printed readable message.

20. Supplying a kit to be used by a cook that includes one or more imaging items, each imaging item having an image transfer device positioned upon the inside surface of a cupcake baking cup, each image transfer device having an image of an edible substance thereon which can be transferred, by being heated, to a cupcake batter positioned within the baking cup during baking.
